(19) United States
(12) Patent Application Publication
(10) Pub. No.: US 2012/0124062 A1
(43) Pub. Date: May 17, 2012

(54) Application Transfer Protocol

(75) Inventors: Steven William Macbeth, Redmond, WA (US); Steven Charles Tullis, Redmond, WA (US); Zhaowei(Charlie) Jiang, Palo Alto, CA (US); Eric P. Gilmore, Bothell, WA (US); Paul A. Viola, Seattle, WA (US)

(73) Assignee: Microsoft Corporation, Redmond, WA (US)

(21) Appl. No.: 12/945,207

(22) Filed: Nov. 12, 2010

(51) Int. Cl. G06F 17/30

(52) U.S. Cl. 707/749; 707/E17.084

(57) ABSTRACT

An application transfer protocol allows users to find applications relevant to a search query in an application search system. The application transfer protocol is used with an index that maintains a database of applications that includes parameters, such as features and/or content of the application. When a user submits a query, the system determines one or more applications relevant to the search query and implements the application transfer protocol to identify and present results to a user.

### BACKGROUND

Recent changes in technology have generated multiple platforms for publisher created applications or “apps.” For example, iPhone® (manufactured by Apple, Inc. in Cupertino, Calif.), iPad® (manufactured by Apple, Inc. in Cupertino, Calif.), Android® (manufactured by Google. in Mountain View, Calif.), Facebook® (manufactured by Facebook in Palo Alto, Calif.), Windows Mobile® (manufactured by Microsoft Corporation in Redmond, Wash.), X-Box® (manufactured by Microsoft, Inc. in Redmond, Wash.), and others are capable of installing and running apps. For the most part, these apps are specific to the platform for which they were designed (e.g., an iPad® app will not run on an Android® device and vice versa). Each platform operates an app store or marketplace of their own apps, etc.

These new technologies offer app publishers many additional opportunities for reward, and have become a catalyst for explosive growth in application development. The result is an organically grown critical mass of applications in the ecosystem. However, current app stores do not provide an effective way to search this ever growing mass of apps.

### SUMMARY

An application transfer protocol allows users to find apps relevant to a search query in an application search system. The application transfer protocol is used with an index that maintains an index of apps that includes parameters, such as features and/or content of the app. When a user submits a query, the system determines one or more apps relevant to the search query and implements the application transfer protocol to identify and present results to a user.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE CONTENTS

The detailed description refers to the accompanying figures. In the figures, the left-most digit(s) of a reference number identifies the figure in which the reference number first appears. The use of the same reference numbers in different figures indicates similar or identical items.

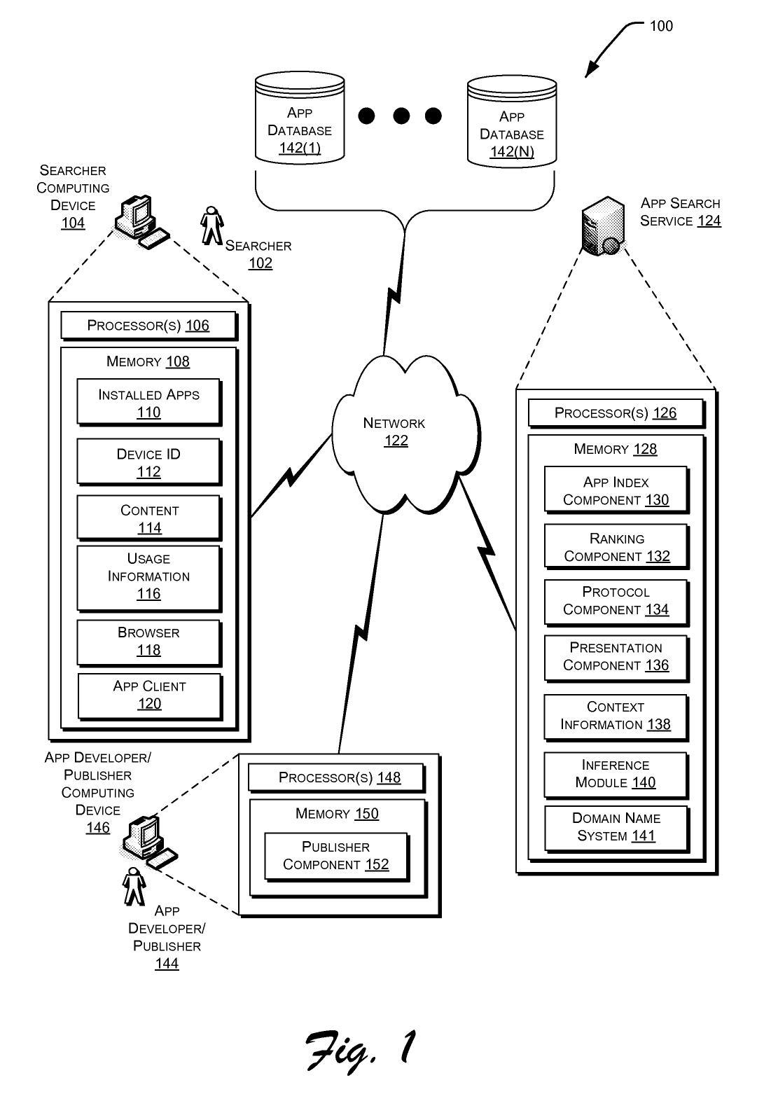

FIG. 1 is a block diagram that illustrates an example application search architecture.

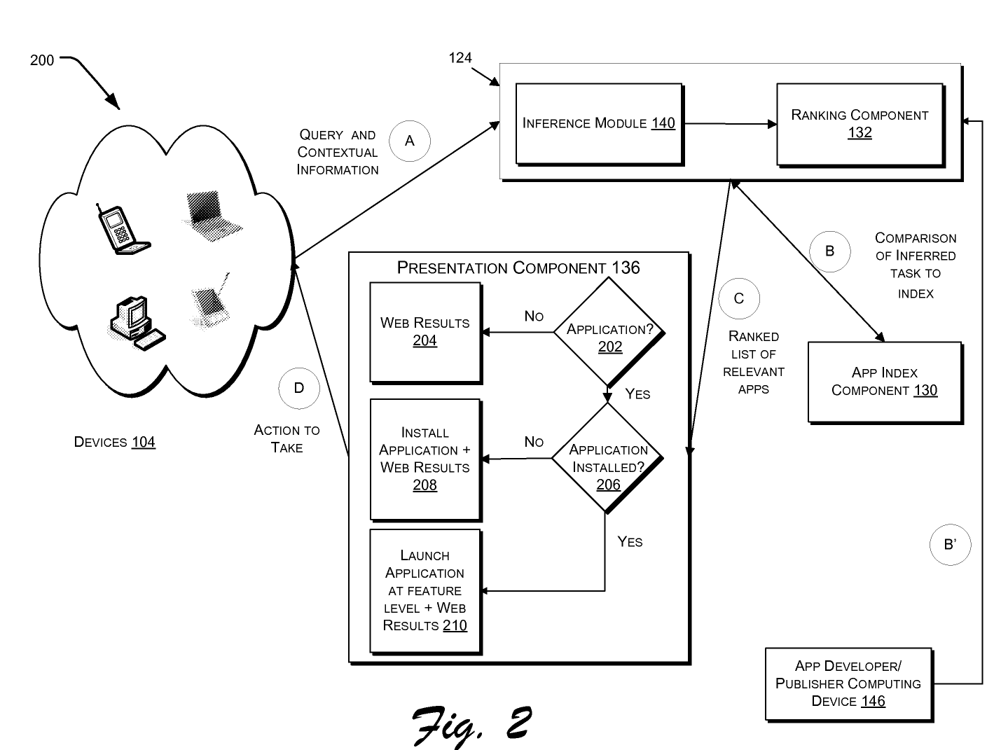

FIG. 2 is a block diagram that illustrates an example application search architecture that includes a results decision structure.

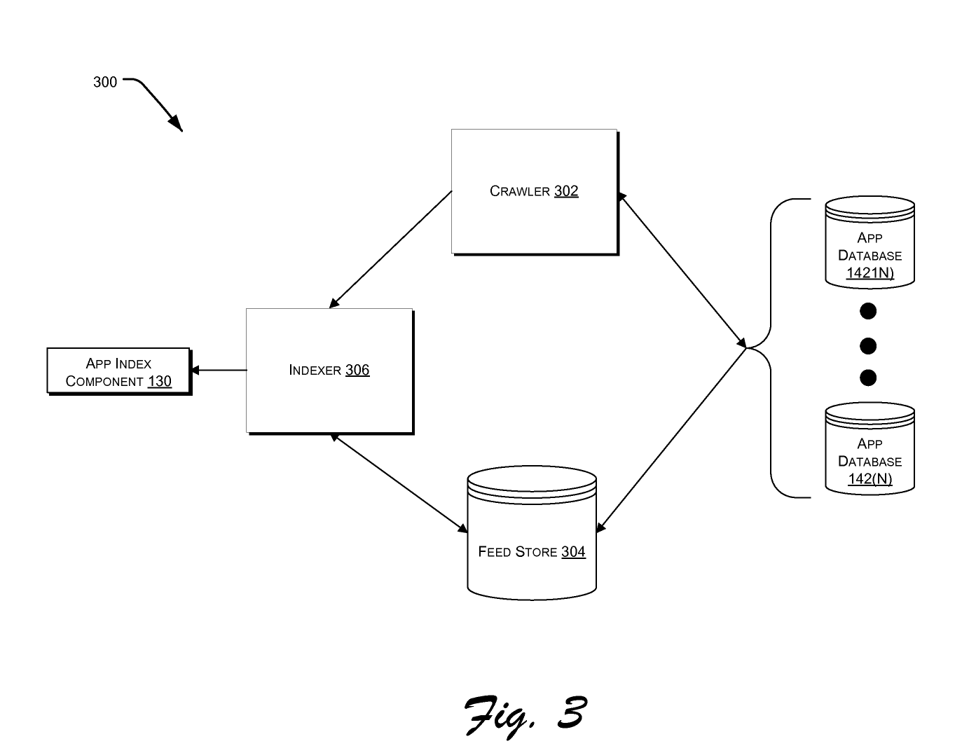

FIG. 3 is a block diagram that illustrates an example indexing architecture.

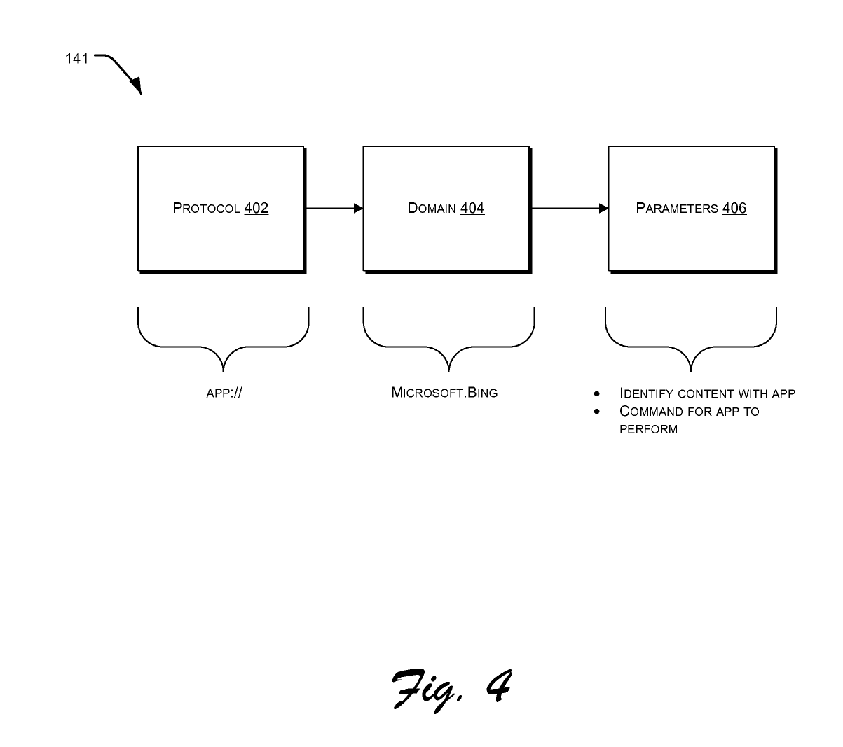

FIG. 4 is a block diagram that illustrates an example protocol architecture.

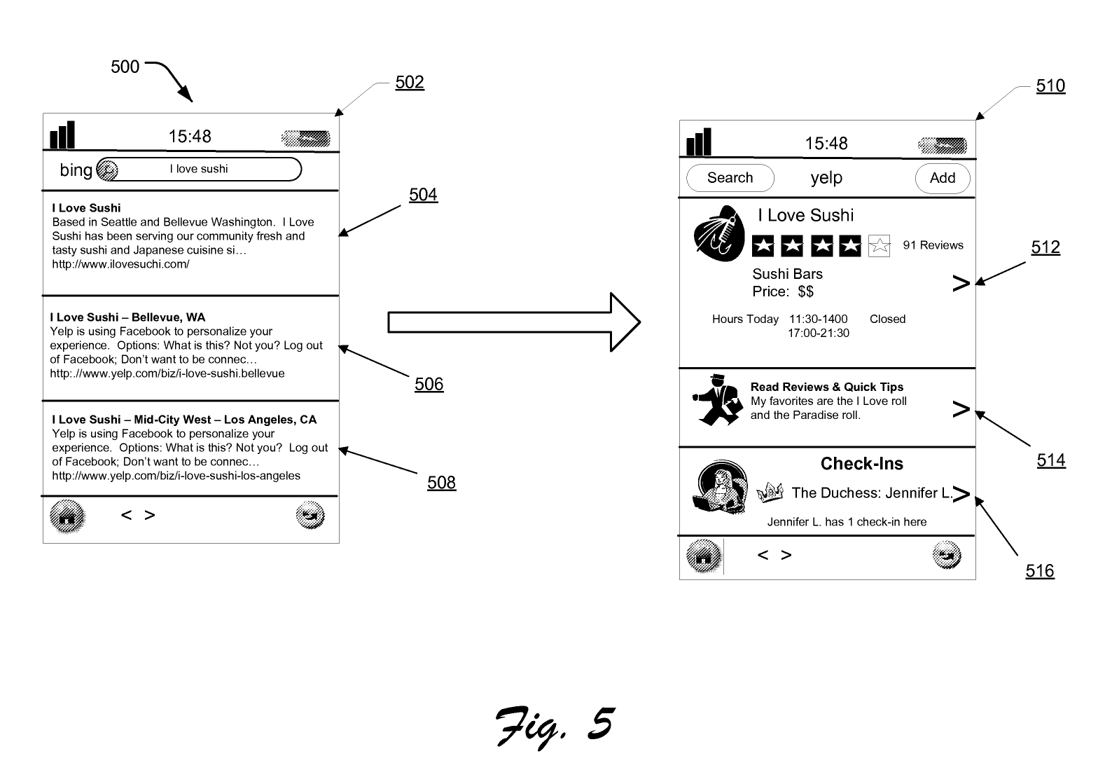

FIG. 5 is a display format of an example search result.

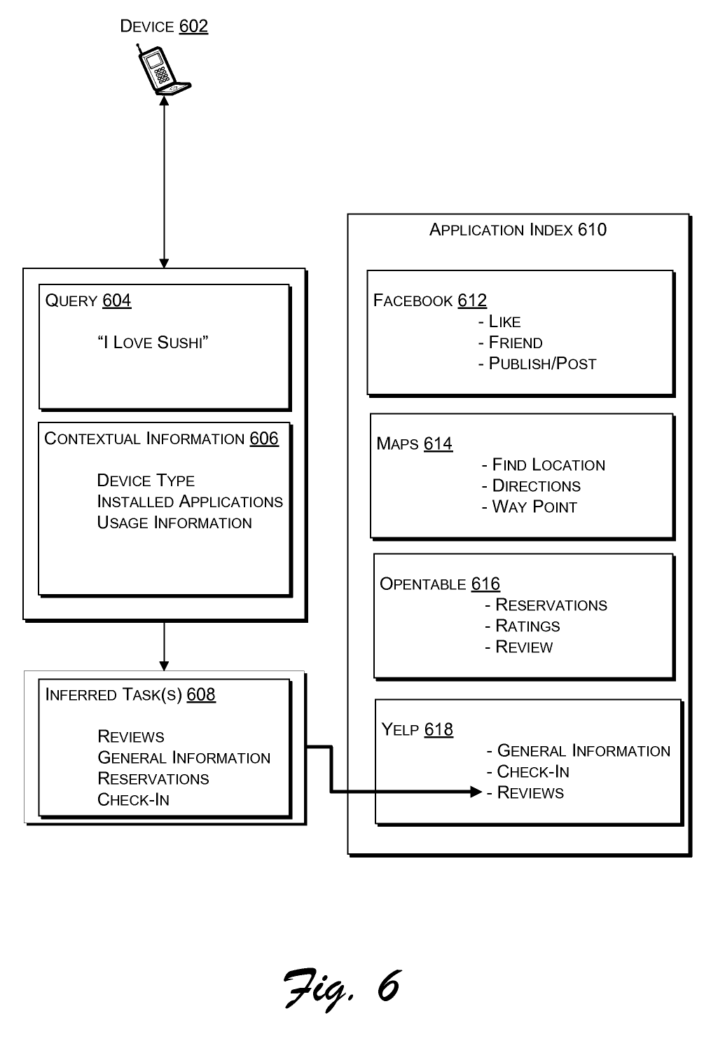

FIG. 6 is a block diagram that illustrates an example call to a specific task within an application.

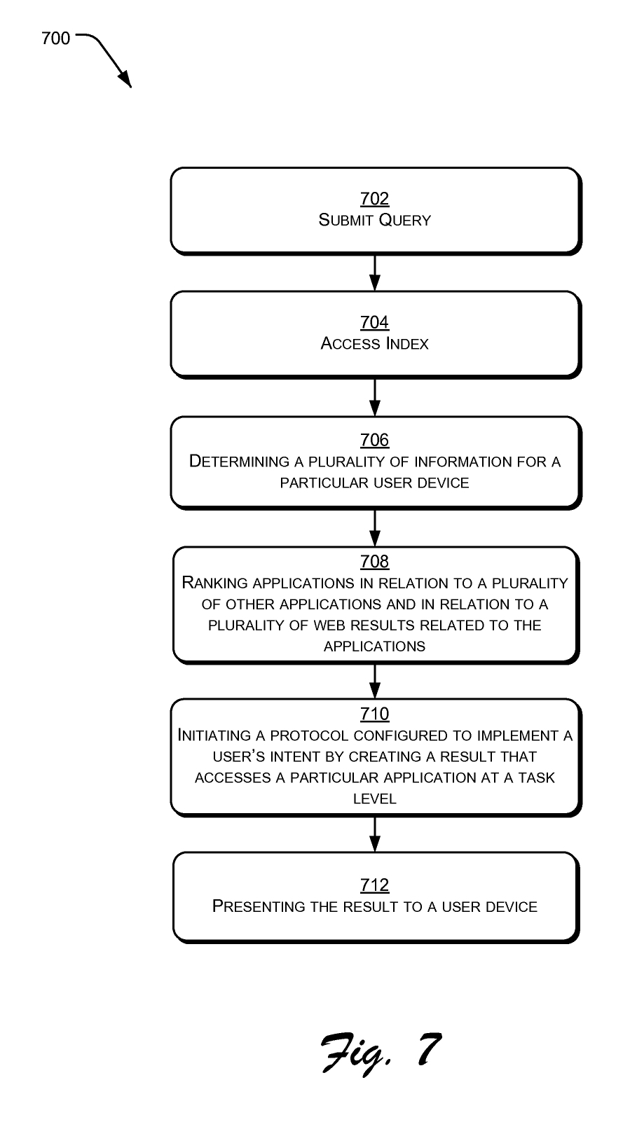

FIG. 7 is a flow diagram of an illustrative process for implementing an application search architecture.

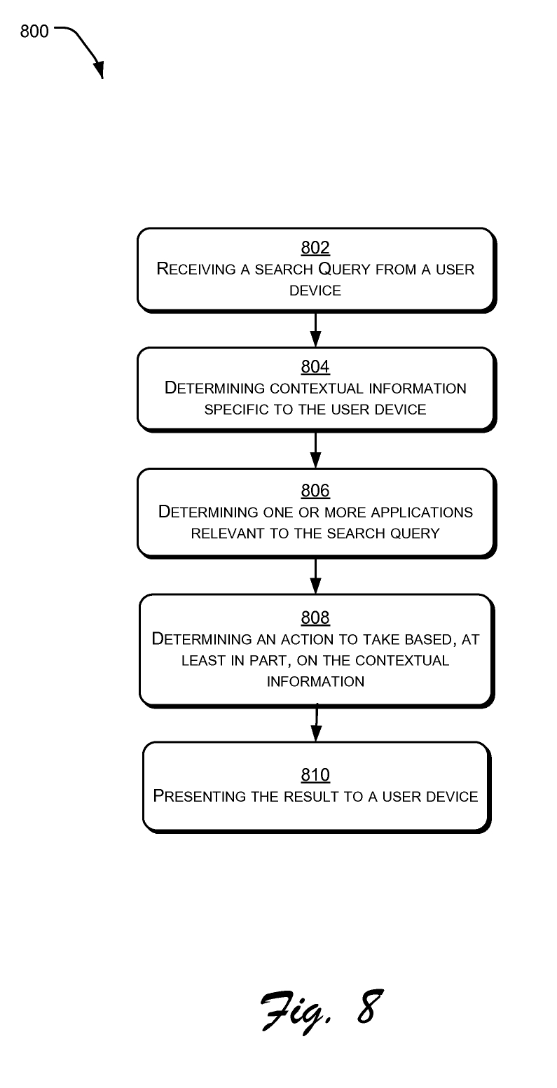

FIG. 8 is a flow diagram of another illustrative process for implementing an application search architecture.

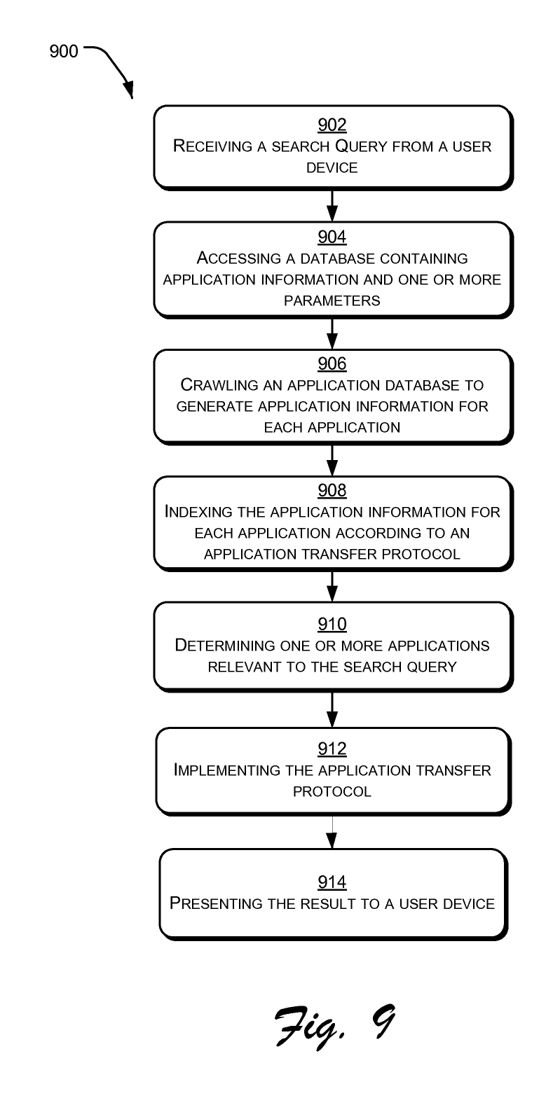

FIG. 9 is a flow diagram of another illustrative process for implementing an application search architecture.

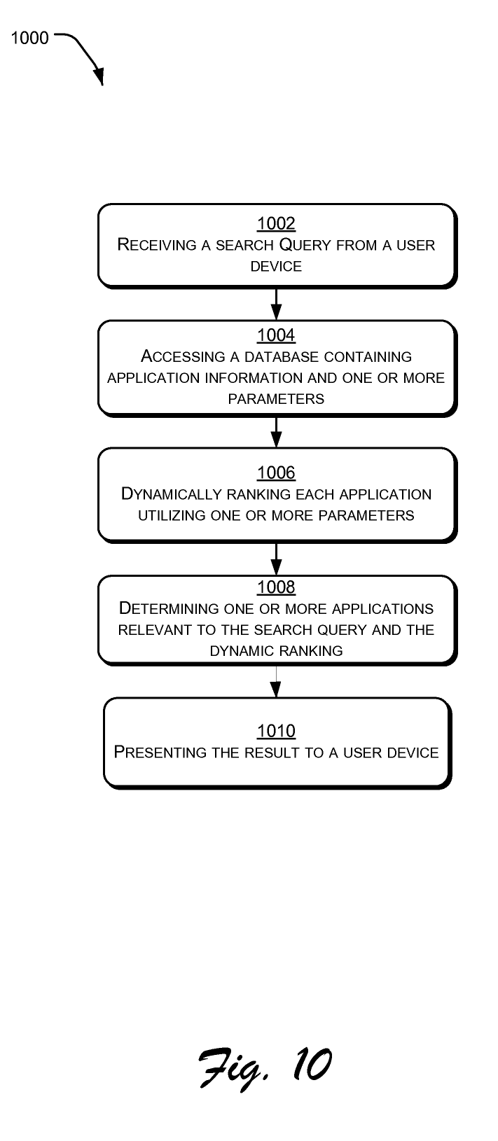

FIG. 10 is a flow diagram of yet another illustrative process for implementing an application search architecture.

### DETAILED DESCRIPTION

### Overview

Today, individual application stores provide marketplace specific discovery tools, however, they are limited to searching a particular application or “app” and linking only to the app from the marketplace's user interface or “UI”.

As discussed above, there are many limitations to this approach. For instance, the user must enter the application store with the intent of “finding an app” vs. a more natural intent to “complete a task.” Current app stores' discovery solutions are device specific and generally provide rudimentary discovery capabilities based on user provided parameters and keywords. Because the user's intent is often to “complete a task,” neither the device nor the associated application store takes into account whether an already installed app will meet the user's need. Moreover, there is currently no way for users to search across multiple app stores and/or the web to obtain the most relevant results from all of these sources simultaneously.

The search architecture described below provides the user with a richer and more useful application search result than has previously been available. From a high-level, given a query, the search provider can infer a task the user is trying to perform. The search provider can also identify if application-based solutions are available and appropriate and rank the available and appropriate applications. Finally, the search provider can check to see if any of the ranked applications are already installed on a user's device and surface a search result such that if the application is not installed, the user is provided a link to the appropriate application store so it can be installed. If the application is already installed, the user can be provided with an entry point to access the app and, more specifically, a feature of the app relevant to the task the user desires to perform. In other words, the user may be taken directly to a specific feature level within the application (e.g., launch an app and initiate a specific action within the app). In one specific example, the system might provide a link to launch a previously installed movie app and to display movie listings for nearby theaters.

The search architecture described below may also include a domain name system that provides a registry of apps according to a protocol that may be used in conjunction with the application search architecture to provide better search results. The protocol may be a part of an index entry in the app database or the app index component and may replace or supplement the familiar http protocol (hypertext transfer protocol) used to transfer and format text and images.

The foregoing explanation provides a brief overview of the application search architecture, however, a more detailed description follows. An illustrative architecture is described, followed by a description of illustrative processes.

### Illustrative Architecture

FIG. 1 illustrates application search architecture 100. Application search architecture 100 includes a searcher 102 that provides input to searcher computing device 104. The input may be in the form of a query to search for applications on the Web. Searcher computing device 104 includes one or more processors 106, memory 108, installed apps 110, device identification or ID 112, content 114, usage information 116, browser 118 and app client 120.

The installed apps 110 include any apps currently installed on the searcher computing device 104. The installed apps 110 are updated as more apps are installed on the searcher computing device 104 such that each time a new search is initiated, a list of installed apps on the searcher computing device 104 is current.

The device ID 112 is a unique identifier for the searcher computing device 104. The device ID 112 may be used to identify the searcher computing device 104 as a device authorized to access, update and/or purchase a particular app. In one example, the device ID 112 comprises the Media Access Control (MAC) address. However, any other unique identifier could be used in other examples.

Content 114 may be in the form of audio or video content as well as text, images or graphical representations. Content 114 may also include any other type of content that is useful to the searcher 102, the particular application or others who may interact with the searcher computing device 104 and is authorized to access the content 114. For example, content 114 may be reviews associated with a particular establishment or maps indicating the location of a particular establishment.

Usage information 116 may include usage of the application by one or more particular users, popularity of the application and social ratings of the application in addition to any other data accumulated for a particular application. The usage of the application may include such items as the amount of time an app is used, the number of times the app is accessed, the features within the app that are accessed, popularity of the application and social ratings of the application in addition to any other data accumulated for a particular app. The usage information for installed applications on the particular device may also include additional indicators for a search provider's dynamic ranking. For example, a user may use the UrbanSpoon™ application more often than the Yelp® application when looking for local restaurants. This information is useful in ranking the applications for that device and user.

Browser 118 may be any commercially available browser such as Bing® from Microsoft Corporation in Redmond, Wash. or Google® from Google in Mountain View, Calif. Browser 118 is the search interface that displays the results of the user's query.

App client 120 provides for management of the installed apps 110 and the various information contained on the searcher computing device 104. Searcher computing device 104 contains contextual information, app information and usage information for the installed apps 110.

The installed apps 110, device ID 112 and usage information 116 are also collectively referred to as contextual information. Contextual information is used to identify information related to the device and to the searcher to assist in the search. As will be discussed further below, content 114 forms a portion of information called parameters. Parameters are features and/or content within an app and include both the various functions to perform a task and also content that is the object of the task. Content 114 may include items such as a map, a review of an establishment or some other type of content relating to the task.

Searcher computing device 104 is connected to a network 122. Network 122 may include one or more wired and/or wireless networks. Network 122 is also connected to other services and applications that interact with the searcher computing device 104.

App search service 124 is one such service that interacts with searcher computing device 104. App search service 124 includes one or more processors 126, memory 128, app index component 130, ranking component 132, protocol component 134, presentation component 136, context information 138, inference module 140 and domain name system 141.

App index component 130 accesses one or more app databases 142(1) . . . 142(N) (collectively “142”). App databases 142 include apps available from one or more app stores and/or different app publishers. In some examples, applications from various sources or application stores are all aggregated and/or searchable across stores in order to obtain results for all different types of devices across all the different applications and different stores. This may be accomplished, in one example, by standardizing protocols across all applications and encouraging broad use by application developers. One such protocol described herein is an app transfer protocol, which is described below with reference to FIG. 4. Application component 128 includes information from each of the applications located on the app database 142. The apps within the app database 142 are indexed in the app index component 130 to provide for organization of the apps. The app index component 130 creates an index that contains metadata describing application information, such as title of the application and tasks the application is able to address.

Ranking component 132 determines the relevance and the ranking of an application in relation to other applications as well as in relation to other traditional web results. Traditional or standard web results include web results that do not directly access a feature of an application or the application itself. This would include such results as the listing one obtains from using the Bing® search engine that may include web sites and online retail stores, etc. The web result may also include descriptions of apps (e.g., those not available for a client device of the user).

The protocol component 134 uses the information from the app index component 130, the ranking component 132 and the parameters and contextual information from the searcher computing device 104 to create a protocol to call the application. As discussed above, the contextual information includes installed apps 110, device ID 112 and usage information 116. Parameters include the content 114 and functions to perform tasks within an app.

The protocol component 134 is used to interpret app data and commands during indexing and searching The interpretation is sufficiently detailed to call an application to a specific feature or task level within the application. For instance, from the user's query and the information described above, the protocol component 134 may conclude that the user wants to see reviews for a particular restaurant. Instead of calling the application at a top level so the home page is called, thus forcing the user to navigate through the application to get to the reviews, the protocol would call the application to the specific feature, which, in this example, is reviews for the particular restaurant in which the user is interested. The protocol component is more fully described in FIG. 3 below.

The presentation component 136 takes the results from the protocol component 134 and displays them in a presentable form to the searcher 102. The results may be presented in different ways depending on the information gathered from the particular device. For instance, it may be that an application for a particular user inquiry is not available. Another possibility is that an application is identified but is not installed on the device. Finally, in the event the application is available, the user is taken to the specific feature within the application that best satisfies the search query.

The presentation component 134 takes into account these different possibilities and presents the searcher 102 with options depending on the results. For instance, if no application exists, the searcher 102 may be presented with standard web results that do not take the searcher to a feature within an app.

In the second possibility, the searcher 102 may be presented with the option to install the identified application when an application is available but not installed on the user's device. This option may be in addition to or instead of presentation of the standard web results. If the searcher 102 selects an option to install the application, the application is installed and once installed; the user 102 may be taken to the specific task in the application that is identified in the application search. The searcher 102 may also decide not to install the application and instead select one of the standard web results.

Finally, in the event an application is identified and it is already installed on the device, the searcher 102 may be taken to the specific task within the application as discussed herein.

The inference module 140 receives both the query and the contextual information from the searcher computing device 104. The contextual information discovered for the searcher computing device 104 may include the type of device being used, an inventory of applications currently installed on the device and/or usage information for the installed applications. The usage information for installed applications on the particular device provides additional indicators for a search provider's dynamic ranking. The information from the inference module 140 is accessed by the ranking component 132 to rank available apps associated with the information from the inference module 140.

The domain name system 141 may provide a registry of apps according to a protocol. The domain name system 141 is optional and, when provided, may be used in the search architecture 100 to improve access to particular features within an application and to improve search across app stores. In the event the domain name system 141 is used, the protocol may be part of an index entry in the app database 142 or the app index component 130. As such, the domain name system 141 may be analogous to the domain name server (DNS) technology employed to direct browser requests for uniform resource locators (URL) on the Internet. Accordingly, the domain name system 141 supplements and/or replaces DNS technology related to apps. In particular, the protocol defined by the domain name system 141 provides enhanced methods of locating, operating, managing, downloading and installing of applications on devices. The domain name system 141 may provide better search, management, transfer, etc., of applications. Accordingly, the protocol may replace or supplement the familiar http protocol (hypertext transfer protocol) used to transfer and format text and images.

The protocol could be standardized across all applications (e.g., the “apps” used by smart phones, personal computers, gaming consoles, TVs and other devices) and could encourage wide adoption by developers. In other examples, the protocol may be applied across less than all app platforms/types. The protocol may be managed in part by the domain name system 141, and may be invoked by identifying or indicating the following aspects: a protocol handler, a domain and parameters.

As described above, the application search architecture 100 is implemented within a computing system environment. For instance, the components of a particular computing system within the environment can include, but are not limited to, one or more processors (e.g., any of microprocessors, controllers, and the like), a system memory, and a system bus that couples the various system components. The one or more processors process various computer executable instructions to control the operation of the computing system and to communicate with other electronic and computing devices. The system bus represents any number of several types of bus structures, including a memory bus or memory controller, a peripheral bus, an accelerated graphics port, and a processor or local bus using any of a variety of bus architectures.

The computing system may be implemented using any form of computer-readable media. Computer-readable media may include, for example, computer storage media and communications media. Computer storage media is configured to store data on a physical memory storage device, while communications media is not configured to store data on a physical memory storage device.

Computer storage media includes volatile and non-volatile, removable and non-removable media implemented in any method or technology for storage of information, such as computer readable instructions, data structures, program modules, or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission memory medium that can be used to store information for access by a computing device. Computer readable storage media does of include modulated data signals, carrier waves or other communication media.

In contrast, communication media may embody computer readable instructions, data structures, program modules, or other data in a modulated data signal, such as a carrier wave, or other transport mechanism.

FIG. 1 also includes an optional component of the application search architecture 100. App developer/publisher 144 may be a third party app developer that controls app developer/publisher computing device 146. App developer/publisher computing device 146 contains one or more processors 148, memory 150 and publisher component 152. In one optional embodiment, app developer/publisher 144 may be a publisher or similar party that wishes to influence the search results caption. The search results caption includes caption text, deep links, branding, etc. and such information can assist in providing a richer solution and better ranking information. App developer/publisher 144 is provided access to the application search architecture 100 and influences the search results by providing this additional information as a part of the ranking component 132. In some examples, the app developer/publisher computing device 146 may provide this additional information according to the example app transfer protocol described herein.

FIG. 2 illustrates an application search architecture 200 and includes details of the presentation component 136. Devices 104 may be any type of computing device, such as a game console, tablet/pad device, TV, netbook, personal computer, mobile phone, a laptop computer, a desktop computer or a personal digital assistant (PDA). The devices 104 submit a query at operation A to the inference module 140. The inference module 140 receives both the query and the contextual information from a particular device 104 (for instance, the device generating the query). The contextual information discovered for a particular device includes the type of device being used, an inventory of applications currently installed on the device and usage information for the installed applications. The usage information for installed applications on the particular device provides additional indicators for a search provider's dynamic ranking. The information from the inference module 140 is accessed by the ranking component 132 to rank available apps associated with the information from the inference module 140. In addition to the information from the inference module 140, operation B provides for information from the app index component 130 that provides the available indexes. In addition, an app developer/publisher computing device 146 may optionally provide information to the ranking component 132 to further enrich the ranking of the apps in operation B′. For example, the app developer/publisher may provide information regarding a newly developed feature of the app or a new use for an existing feature of the app. The app developer/publisher may also provide information regarding interoperability with another app or popularity of apps and/or features from other sources. In operation C, the ranked list of apps is sent to the presentation component 136. The ranking component 132 determines the relevance and the ranking of an application in relation to other applications as well as in relation to other traditional web results. Thus, the ranking component 132 determines the application that best satisfies the search query as the result of the ranking. This information is then submitted to the presentation component 136.

The presentation component 136 determines the final result to be presented on the device 104. The presentation component 136 uses the information aggregated from the ranking component 132 to determine whether an application in response to the search query exists in operation 202. If an application does not exist, then web results are presented to the user in operation 204. If an application does exist, operation 206 determines whether an identified application is installed on the device 104. If the application is not installed, the application is installed and presented to the user at a specific feature level along with or without the web results in operation 208. The system may also be set up to ask the user whether or not to install the application before the system installs the application. In one example, the service will provide opt-in and/or opt-out functionality. For example, in one instance, prior to an application being installed, the user will be notified and given the option to opt-out. Further, in one aspect, enhanced security measures will be employed in order to protect the user and/or application data.

If the application is installed, the application is launched at a specific entry point to a task or feature of the application in response to the search query and presented to the user with or without the web results in operation 210.

FIG. 3 illustrates an example indexing architecture 300 that includes a results decision structure. App databases 142 include apps available from one or more app stores and/or different app publishers. In some examples, applications from various sources or application stores are all aggregated and/or searchable across stores in order to obtain results for all different types of devices across all the different applications and different stores. The information from the app database 142 is made available to a crawler 302 and/or a feed store 304. The crawler 302 searches through the information in the app database 142 for pertinent information relating to each of the apps within the app database 142. As shown in FIG. 3, the information flow between the crawler 302 and the app database 142 is bi-directional, thus providing enhanced or improved quality of information in both the crawler 302 and the app database 142. At the same time, information from the app database 142 may be provided to the feed store 304. The feed store 304 stores information from the app database 142 for each app and fees this information to the indexer 306 as new information becomes available (e.g., in the form of an RSS feed). The combined information from the feed store 304 and the crawler 302 is provided to the indexer 306 for organization. The indexer 306 accumulates the information from the crawler 302 and/or the feed store 304 into a format usable by the app index component 130 that provides a useful result in response to a submitted query. The information provided to the indexer 306 from the feed store 304 is also bi-directional such that the information to both the indexer 306 and the feed store 304 is continually updated similar to the continual updating that occurs between the crawler 302 and the app database 142.

Referring to FIG. 4, the domain name system 141 may provide a registry of apps according to a protocol. The protocol may be a part of an index entry in the app database or the app index component described earlier. As such, the domain name system 141 may be analogous to the domain name server (DNS) technology employed to direct browser requests for uniform resource locators (URL) on the Internet. Accordingly, the domain name system 141 supplements and/or replaces DNS technology related to apps. In particular, the protocol provides enhanced methods of locating, operating, managing, downloading and installing of applications on devices. In one example, the domain name system 141 may be used in conjunction with the application search architecture of FIG. 1. The domain name system 141 may provide better search, management, transfer, etc., of applications. Accordingly, the protocol may replace or supplement the familiar http protocol (hypertext transfer protocol) used to transfer and format text and images.

The protocol could be standardized across all applications (e.g., the “apps” used by smart phones, personal computers, tablet/pad devices, gaming consoles, TVs and other devices) and could encourage wide adoption by developers. In other examples, the protocol may be applied across less than all app platform/types. The protocol may be managed in part by the domain name system 300, and may be invoked by identifying or indicating the following aspects: the protocol 402, a domain 404 and parameters 406.

In one example, the protocol 402 may be identified by a protocol handler; for example, “app://”. Accordingly, a name such as “app://” may identify a protocol to augments the familiar http:// protocol handler (i.e., the app:// protocol is used for applications and the http:// protocol is used for web pages. The domain and/or top level domain 404 may be identified (strictly for purposes of example only, and not as a required feature) as “microsoft.bing,” optionally with a top level domain such as “.com” or “.org.” The app DNS system may be administered by an authority analogous to Internet Corporation for Assigned Names and Numbers (ICANN). This is by way of example only, and the example would allow a user to access and/or manage an application associated with the Bing® service provided by Microsoft®. It is equally likely that this protocol will be callable by other applications and services. In another example, the Bing® iPhone® app may be able to leverage this service to call into other applications also installed on the same iPhone®. In yet a further example, the domain level 404 could be indicated by “corporation.department” or similar, as required to indicate a particular application or resource. The parameters 406 may include, by way of example and not limitation, one or more search term(s) used to find an application, content associated with the app from a device or other locations, input variable values for use by a specifically identified application, a command to an application and/or to an application store, server or host of the application. A generic protocol may be generated in the form of app://corporation.application/parameters. The application portion and/or the parameters portion may define a version of an app and/or a platform on which the app is to run.

Consequently, in one specific example, the protocol architecture 141 may read app://microsoft.bing/restaurant/ilikesushi.com/bellevue/reviews in response to a query that results in the user's intent being restaurant reviews for a restaurant called I Like Sushi in Bellevue, Wash. and employing the Bing® app from Microsoft Corporation.

FIG. 5 illustrates a display format of an example search result 500. Search page 502 is a list of search results from a search using the Bing® search engine app in response to a search for “i love sushi.” Search page 502, in this example, displays three results. The first result 504 is for an overall web site for all the I Love Sushi restaurants. The second result 506 is for the Bellevue, Wash. I Love Sushi restaurant and the third result 508 is for the Los Angeles, Calif. I Love Sushi restaurant. In this example, the user's intent from the search results is for reviews for the I Love Sushi restaurant in Bellevue, Wash. Application page 510 illustrates the result of the application search using the Yelp® application. Using the application search architecture 100 from FIG. 1, the architecture has identified that in this instance, Yelp® is the best application to use for the query result. For example, in the instance Yelp® may be the best application due to the quantity and quality of search results generated in this particular search. The I Love Sushi information may include ratings, price and hours of operation information section 512, a reviews section 514 and a check-in section 516. Other example sections may include a reservations section and a directions section. In this example, since the user is looking for reviews for the Bellevue I Love Sushi restaurant, the protocol would call reviews section 516 and the user would be directed to that point or feature in the Yelp® application instead of the generic yelp.com or Yelp® app in which the user would have to navigate to the reviews section. Consequently, the application search architecture not only identifies the optimal application to use but the user is also taken to the specific place or feature within the application in which the user is interested.

FIG. 6 illustrates an example call to a specific feature level within an application. Device 602 submits a query 604. In this example, the query is “I Love Sushi”. Contextual information 606 is located on the device 602. Contextual information 606 may include device type, an inventory of installed applications and usage information. As described above, usage information may include usage of the application and social ratings of the application in addition to any other data accumulated for a particular application. The usage of the application may include such items as the amount of time an app is used, the number of times the app is accessed, the features within the app that are accessed, popularity of the application and social ratings of the application in addition to any other data accumulated for a particular app. The usage information for installed applications on the particular device may also include additional indicators for a search provider's dynamic ranking. In the illustrated example, the usage information may be used to determine that the user uses the Yelp® app more often than another restaurant app and therefore, Yelp® is the better app to use in this instance.

The query 604 and the contextual information 606 is used by inferred task(s) 608 to determine an entry point or task within an app to access in response to the query 604. The inferred task(s) 608 includes general information about each installed application on the device 602 and other more detailed information, such as reservations, check-in information and reviews. These are examples that may apply to a restaurant such as in the current example. Other applications may include many different features depending on the focus of the application. FIG. 6 shows “Reviews” listed first since, in this example, the search query and analysis has inferred that the customer desires to go directly to reviews about the restaurant based on the query 604 and the contextual information 608.

The inferred task 608 and contextual information 606 are used in the architecture to rank applications in response to the query 604 in the application index 610. In this example, the application index 610 has identified several applications including Facebook 612, Maps 614, OpenTable 616 and Yelp 618. The architecture uses the query 604 and the contextual information 606 and the inferred tasks 608 to rank the applications and direct the user to a specific feature level within the chosen application as the result of the search. In this example, the ranking has identified Yelp® as the highest ranked app and Reviews as the inferred task the user desires to access. Consequently, the user is taken directly to the reviews section in Yelp® so the user can either write a review or read the existing reviews.

This is very helpful to the user because in the past, search results simply identified an application and took the user to the application. The user then had to navigate through the application to find the particular feature the user wanted. This mechanism greatly reduces the user's efforts.

### Illustrative Process

FIG. 7 is a flow diagram of an illustrative process 700 for implementing an application search architecture. The process 700 may, but need not, be implemented using the system/environment of FIGS. 1-6. In operation 702, a query is received from a user of a client device, such as searcher computing device 104. The query may be input by a user. The architecture accesses an index in operation 704 in response to the query. The index is a database in which the information is indexed to provide useful information in assessing the query. The information in the database includes aggregated information for a number of applications from a number of different sources and servers. From the database, an index is created that contains contextual information describing application information, device information and user engagement information. The index may also include other metadata information as well as the protocol described above.

Operation 706 determines a plurality of information for a particular user device. The information discovered for a particular device includes the device being used; an inventory of applications currently installed on the device and usage information for the installed applications and the usage information for installed applications on the particular device provides additional indicators for a search provider's dynamic ranking.

In operation 708, applications are ranked in relation to a plurality of other applications and in relation to a plurality of web results. Web results are traditional or standard web results that include web results that are not specifically directed to an entry point in an application.

A protocol is initiated to implement a user's intent by creating a result that accesses a particular application at a task level in operation 710. The protocol is sufficiently detailed to call an application to a specific task within the application. The query and the data from operations 704, 706 and 708 are used to configure the protocol.

The result is presented to the client device in operation 712. The result is typically directed to a specific task within an application installed on the client device. However, this operation may also include offering other options in the event the application is not available or is not installed on the user's device.

FIG. 8 is a flow diagram of an illustrative process 800 for returning search results in an application search architecture. In operation 802, a query is received from a user device or client device. The query may be input by a user. The architecture determines contextual information specific to the user device in operation 804. The contextual information may include information such as the type of device, the device ID, the apps installed on the device and usage information relating to the installed apps.

Operation 806 determines one or more applications relevant to the search query. As stated earlier, the architecture will use the ranking component and the query, contextual information and app index information to arrive at the one or more applications determined to be relevant.

In operation 808, an action to take is determined based, at least in part, on the contextual information. The contextual information is important in determining the intent of the user in connection with the search query.

The result is presented to the user in operation 810. The result is typically directed to a specific task or feature within an application installed on the user device. However, this operation may also include offering other options in the event the application is not available or is not installed on the user's device.

FIG. 9 is a flow diagram of an illustrative process 900 for implementing an application search architecture. In operation 902, a query is received from a user device. The query may be input by a user. The architecture accesses a database containing application information and one or more parameters in operation 904. The one or more parameters may include identification of content within an application, commands to enable an application to access specific content within the application and commands able to instruct an application to perform a specific feature to perform a task.

Crawling an application database to generate application information for each application is conducted in operation 906. The information obtained from crawling the application database is used in constructing the index of the applications in the application database.

In operation 908, the application information is indexed for each application according to an application transfer protocol. The application transfer protocol may be in the generic form of app://company.application/one or more parameters.

One or more applications are determined to be relevant to the search query in operation 910 and the application transfer protocol is implemented in operation 912. The result is presented to the client device in operation 914.

FIG. 10 is a flow diagram of an illustrative process 1000 for implementing an application search architecture. In operation 1002, a query is received from a user device. The query may be input by a user. The architecture accesses a database containing application information and one or more parameters in operation 1004. The one or more parameters may include identification of content within an application, commands to enable an application to access specific content within the application and commands able to instruct an application to perform a specific feature to perform a task.

In operation 1006, each application is dynamically ranked utilizing the parameters. One or more applications are determined to be relevant to the search query and the dynamic ranking in operation 1008. The results are presented to the client device in operation 1010.

Although the subject matter herein has been described in language specific to structural features and/or methodological operations, it is to be understood that the subject matter defined in the appended claims is not necessarily limited to the specific features or operations described above. Rather, the specific features and acts described above are disclosed as example forms of implementing the claims.

1. One or more computer-readable media storing computer-executable instructions that, when executed, configure one or more processors to perform acts comprising:
receiving a search query from a user device;
accessing an index containing application information and one or more parameters from a plurality of application databases;
determining, in response to receipt of the search query and the application information, one or more applications relevant to the search query and the application information; and
returning search results in an application transfer protocol that is uniform across the plurality of application databases, the application transfer protocol based, at least in part, on database information being derived from the application information and the one or more parameters.

2. The one or more computer-readable media of claim 1, wherein the one or more parameters includes an identification of content within the particular application, commands to enable the particular application to access specific content within the particular application, and/or commands able to instruct the particular application to perform a specific feature to perform a task.

3. The one or more computer-readable media of claim 1, wherein the application information includes a name for the particular application and an originating entity for the particular application.

4. The one or more computer-readable media of claim 1, wherein the application transfer protocol is in the generic form of application specific protocol+domain+parameters.

5. The one or more computer-readable media of claim 4, wherein the application specific protocol is a generic application protocol handler designating that the entry represents an application.

6. The one or more computer readable media of claim 4, wherein the domain is a domain name specific to the particular application, and includes an identifier of an originating entity and an identifier of the particular application.

7. The one or more computer-readable media of claim 1, wherein the application transfer protocol is in the specific form of app://company.application/one or more parameters.

8. The one or more computer-readable media of claim 1, further comprising interpreting an application namespace in the protocol using a Domain Name System to interpret one or more protocol links.

9. The method of claim 1, the acts further comprising receiving input from a developer of an application in determining a result.

10. A method of indexing applications comprising:
under control of one or more processors configured with executable instructors:
crawling a plurality of application databases to generate a plurality of application information for each application in the plurality of application databases;
indexing the plurality of application information for each application in the plurality of application databases according to an application transfer protocol.

11. The method of claim 10, the plurality of application information comprising:
a collection of applications containing task-centric features;
a plurality of content related to a particular application in the collection of applications; and
a plurality of metadata providing one or more parameters of each application in the collection of applications.

12. The method of claim 11, the one or more parameters comprising identification of a particular type of user device to which each application is targeted and/or identification of a plurality of tasks each application is configured to perform.

13. The method of claim 10, further comprising ranking each application utilizing the one or more parameters.

14. The method of claim 13, further comprising ranking each application in relation to one or more web results resulting from a submitted query.

15. The method of claim 13, further comprising ranking each application in relation to the plurality of other applications in the application index.

16. The method of claim 13, further comprising supplementing the application index with additional information about an application, of the collection of applications, provided by a developer of the application to improve the dynamic ranking of each application.

17. The method of claim 16, the additional information comprising:
textual information associated with the application;
deep links to a particular feature within the application; and
branding information associated with the application.

18. A method of generating a search index of applications comprising:
under control of one or more processors configured with executable instructors:
generating index entries for a plurality of applications, each index entry comprising:
a generic application protocol handler designating that the entry represents an application;
a domain name specific to the respective application; and
one or more parameters of the respective application.

19. The method of claim 18, wherein the one or more parameters includes an identification of content within the respective application, commands to enable the respective application to access the specific content within the application, and/or commands usable to instruct the application to perform a specific feature to perform a task.

20. The method of claim 17, wherein the index entry for a plurality of applications is in the form of app://company.application/one or more parameters.
